(19) United States
(12) Patent Application Publication
(10) Pub. No.: US 2025/0262721 A1
(43) Pub. Date: Aug. 21, 2025

(54) MULTI-PURPOSE CUTTING TOOL

(71) Applicant: Snap-on Incorporated, Kenosha, WI (US)

(72) Inventors: Anup A. Gupte, Buffalo Grove, IL (US); David T. Doyle, Pleasant Prairie, WI (US); David T. Ross, Antioch, IL (US); George R.R. Call, Milwaukee, WI (US)

(73) Assignee: Snap-on Incorporated, Kenosha, WI (US)

(21) Appl. No.: 18/442,272

(22) Filed: Feb. 15, 2024

(51) Int. Cl. B25B 7/02; B25B 7/06; B25B 7/22

(52) U.S. Cl. CPC B25B 7/02; B25B 7/06; B25B 7/22

(57) ABSTRACT

A multi-function tool that is adapted to cut various materials and has multiple features. The tool includes first and second halves pivotally coupled together at a pivot and respective first and second jaw portions. A first cutting section is cooperatively formed by first and second cutting edges respectively disposed on the first and second jaw portions, and a second cutting section is cooperatively formed third and fourth cutting edges respectively disposed on the first and second jaw portions. A grip feature and/or a wire stripping feature may also be defined by a grooves or indents disposed on the first or second jaw portions between the first and second cutting portions.

### TECHNICAL FIELD OF THE INVENTION

The present invention relates generally to hand-held wire cutting and manipulation tools.

### BACKGROUND OF THE INVENTION

A user may be required to perform a variety of functions involving wire with hand-held tools. For example, the user may need to perform cutting functions along with additional functions, such as pulling, turning, twisting, crimping, and/or gripping a wire or other work piece. The technician may also need to strip protective plastic coatings from wires and cut materials, such as wires, having different characteristics, such as hardnesses and/or thicknesses.

Tools for respectively performing these individual functions are available. For example, pliers having opposing flat gripping surfaces may be used for gripping or pulling a wire or other work piece. Wire-stripping tools are also available to remove an outer protective layer of insulation from a wire, while avoiding cutting or damaging the wire under the insulation. There are also a variety of tools for performing cutting functions. However, to perform all of these functions, numerous tools are required.

### SUMMARY OF THE INVENTION

The present invention relates broadly to a multi-purpose tool including multiple features to perform a variety of different functions. The tool includes a first cutting section cooperatively formed by first and second cutting edges respectively disposed on the first and second jaw portions, and a second cutting section cooperatively formed third and fourth cutting edges respectively disposed on the first and second jaw portions. The first and second cutting sections have different characteristics. For example, the first cutting section may be disposed distal to the pivot point (proximal to a tip of the jaw portion), and be adapted to provide a flush cut, and the second cutting portion may be adapted to provide a diagonal cut. The first cutting section is positioned proximal to the tip for easier use in tight spaces, while the second set of cutting edges are positioned proximal to the pivot to maximize leverage when cutting material. A grip feature may be formed by a groove on the first jaw portion between the first and second cutting sections, and the feature may be adapted to perform, for example, a wire-stripping function. Alternately, the feature may be adapted to perform a gripping, pulling, and/or twisting function, or be adapted to otherwise manipulate a wire or other component.

In another embodiment, the present invention includes first and second halves pivotally coupled together at a pivot and respectively having first and second jaw portions. The tool includes a first cutting section cooperatively formed by first and second cutting edges respectively disposed on the first and second jaw portions, and a second cutting section cooperatively formed third and fourth cutting edges respectively disposed on the first and second jaw portions, where the second cutting section is disposed proximal to the pivot in relation to the first cutting section. A wire-stripping feature may also be defined by first and second grooves respectively disposed on the first and second jaw portions respectively between the first and second cutting portions.

In another embodiment, the present invention includes first and second halves pivotally coupled together at a pivot and respectively having first and second jaw portions. The tool includes a first cutting section cooperatively formed by first and second cutting edges respectively disposed on the first and second jaw portions, and a second cutting section cooperatively formed third and fourth cutting edges respectively disposed on the first and second jaw portions, where the second cutting section is disposed proximal to the pivot in relation to the first cutting section. A grip feature may also be defined by a first groove disposed on the first jaw portion between the first and second cutting sections. A wire-stripping feature defined by indents may also be respectively disposed on the first and second jaw portions between the first and second cutting sections.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side perspective view of a first side of a cutting tool, according to an embodiment of the present invention.

FIG. 2A is a side perspective view of a second side of a first half of the cutting tool of FIG. 1.

FIG. 2B is perspective view of a second side of a second half of the cutting tool of FIG. 1.

FIG. 3A is a plan view of a second side of the cutting tool of FIG. 1.

FIG. 3B is a section view of the cutting tool taken along line B-B of FIG. 3A.

FIG. 3C is a section view of the cutting tool taken along line A-A of FIG. 3A.

FIG. 4 is a side plan view of the cutting tool of FIG. 1.

FIG. 5 is a front plan view of the cutting tool of FIG. 1.

FIG. 6 is an enlarged side view of a first side of a jaw portion of the cutting tool of FIG. 1.

FIG. 7 is a perspective view of a second side of the jaw portion of the cutting tool of FIG. 1.

FIG. 8 is a perspective view of a first side of a cutting tool, according to another embodiment of the present invention.

FIG. 9A is a plan view of the cutting tool of FIG. 8.

FIG. 9B is a section view of the cutting tool taken along line B-B of FIG. 9A.

FIG. 9C is a section view of the cutting tool taken along line A-A of FIG. 9A.

FIG. 10 is a perspective view of a first side of a jaw portion of the cutting tool of FIG. 8.

FIG. 11 is a perspective view of a second side of the jaw portion of the cutting tool of FIG. 8.

FIG. 12 is a perspective view of a first side of a cutting tool, according to an embodiment of the present invention.

FIG. 13 is a perspective view of a first side of a jaw portion of the cutting tool of FIG. 12.

FIG. 14 is a perspective view of a second side of the jaw portion of the cutting tool of FIG. 12.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to a tool for performing a variety of functions with wire or the like. The tool includes handles and a pivot for pivotably connecting the handles together. The handles respectively include jaws that include two cutting edges. For example, the jaws cooperatively define a first cutting section and a second cutting section having different characteristics, and a feature disposed between the first and second cutting sections. The first cutting section may be located proximal to the tip and has a geometry to cooperatively flush-cut soft material. The second cutting section may have a geometry to cooperatively diagonal-cut soft/hard material. The first cutting section is placed proximal to the tip for easier use in tight spaces, while the second cutting section is positioned proximal to the pivot to maximize leverage when cutting material. The lengths of the respective edges can be tailored to the desired application. The jaws may also include a grip feature defined by grooves on each of the first and second jaws. The jaws may also be asymmetrical, where the groove is only present on one jaw. The grip feature may be used to perform a variety of functions including gripping, pulling, and/or twisting function, or be adapted to otherwise manipulate a wire or other component. The jaws may also include a wire-stripping feature defined by indents on each of the first and second jaws. The gripping feature and/or wire-stripping feature may be disposed between the two cutting edges on each of the jaws.

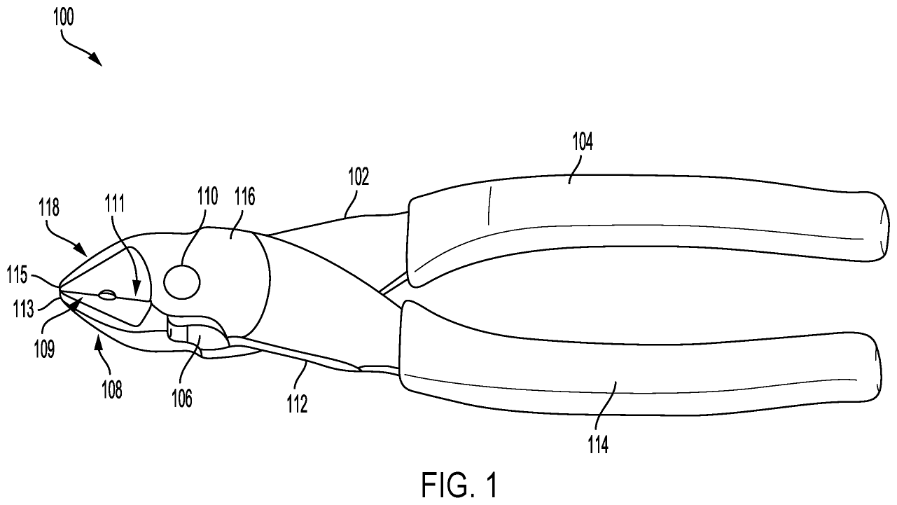

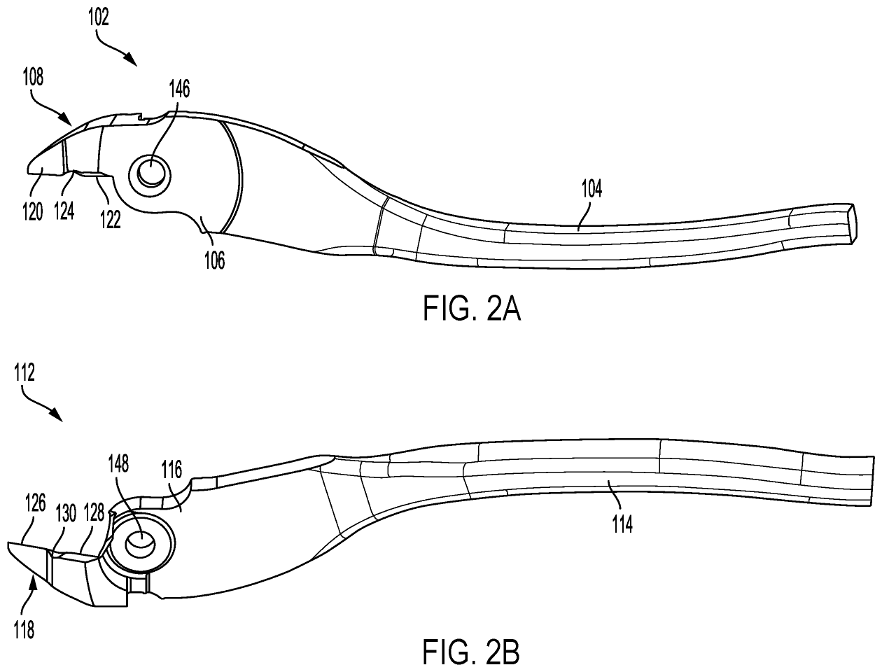

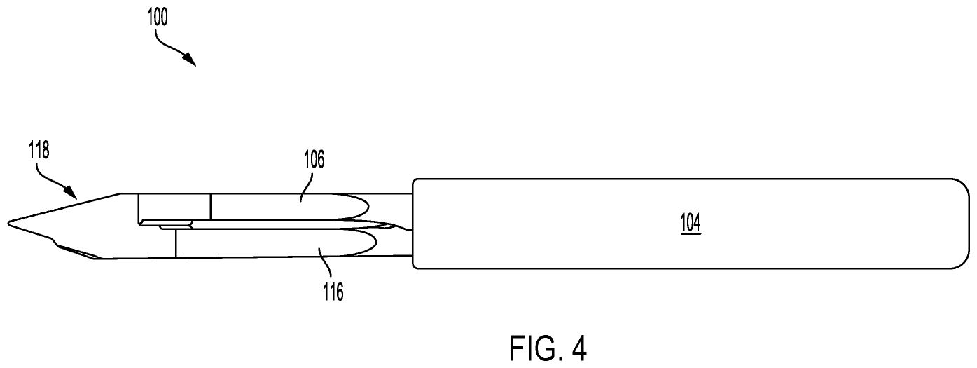

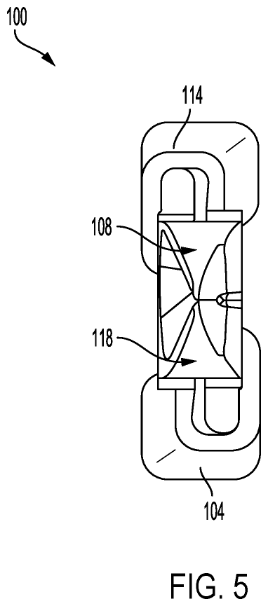

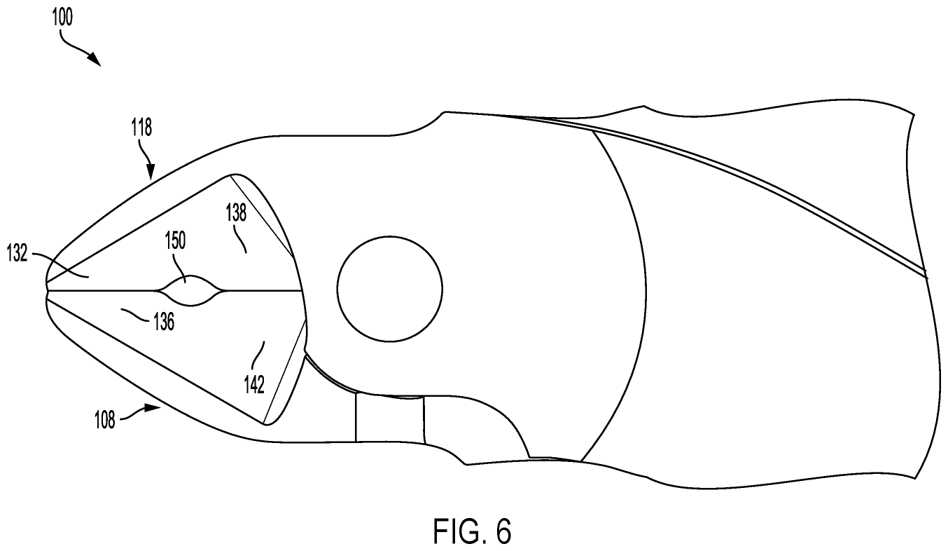

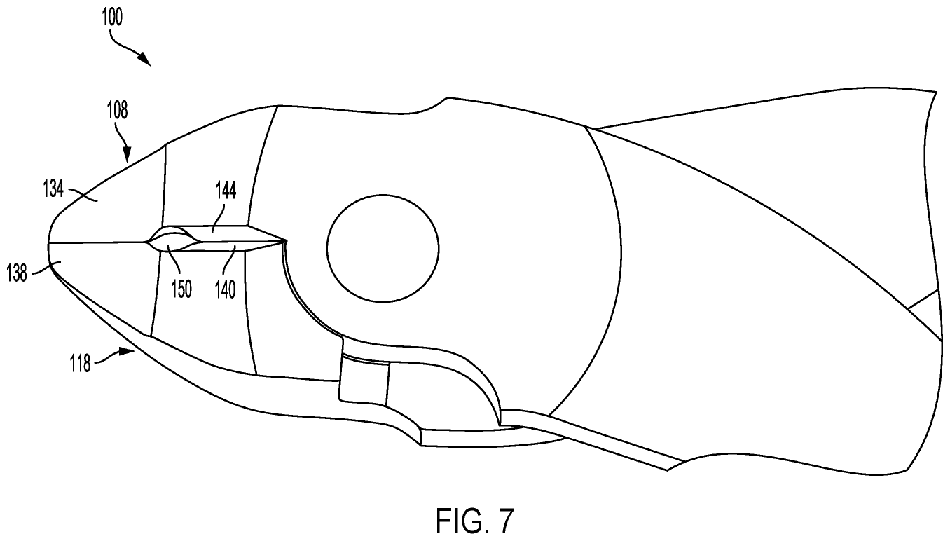

Referring to FIGS. 1-7, a pliers-type tool 100 includes first and second halves 102, 112. The first half 102 includes a first handle portion 104, a first joint portion 106, a first jaw portion 108, and a first aperture 146. The first aperture 146 may be disposed in the first joint potion 106. The second half 112 includes a second handle portion 114, a second joint portion 116, a second jaw portion 118, and a second aperture 148 adapted to pivotally couple with the first aperture 146 via pivot 110, thus allowing the first and second halves 102, 112 to pivot relative to each other.

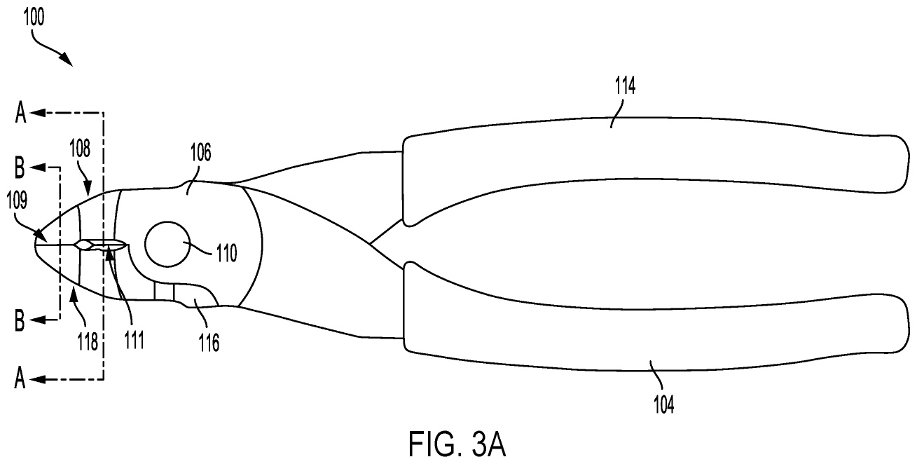

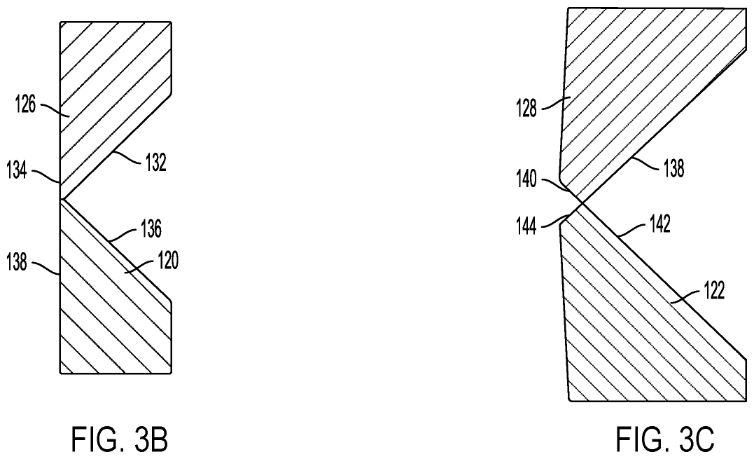

In an embodiment, the first and second jaw portions 108, 118 may respectively include first and second tips 113, 115. The first and second jaw portions 108, 118 also have first and second cutting edges 120, 126 cooperatively having a first cutting characteristic, and third and fourth cutting edges 122, 128 cooperatively having a second cutting characteristic that is different than the first and second cutting edges 120, 126. The first cutting edge 120 and the second cutting edge 126 may define a first cutting section 109, and the third cutting edge 122 and the fourth cutting edge 128 may define a second cutting section 111. As shown in FIG. 3A, 3B, and 3C, the first and second cutting sections 109, 111 may respectively have different cross-sections that respectively and cooperatively provide different cutting properties. The first cutting edge 120 of the first jaw portion 108 may be formed by walls 132, 134 of the first jaw portion 108, and the second cutting edge 126 of the second jaw portion 118 may be formed by walls 136, 138 of the second jaw portion 118. As shown in FIG. 3B, the first cutting edge 120 of the first jaw portion 108 is defined by the angled wall 132 and a flat wall 134, and the second cutting edge 126 of the second jaw portion 118 is defined by the angled wall 136 and flat wall 138. The first cutting edges 120, 126 define the first cutting portion 109, which may be adapted to cooperatively provide a flush-cutting function. The flat walls 134, 138 are substantially parallel to a cutting plane, where the cutting plane extends in the direction of the longitudinal axis of the tool 100 and is perpendicular to a pivot axis of the tool 100. The flat walls 134, 138 are substantially co-planar with each other. The angled walls 132, 136 respectively form an acute angle with the flat walls 134, 138 to form the respective first and second cutting edges 120, 126. A flush-cut refers to a wire cut where the part of the wire that was cut has a substantially flat surface due to the geometry of the cutting edges of the tool.

As shown in FIG. 3C, the third cutting edge 122 of the first jaw portion 108 may be formed by walls 138, 140 (also referred to as angled walls) of the first jaw portion 108 which cooperatively form a V-shape, and the fourth cutting edge 128 of the second jaw portion 118 may be formed by walls 142, 144 (also referred to as angled walls) of the second jaw portion 118 which cooperatively form a V-shape. As shown, all of the walls 138, 140, 142, 144 are angled walls that form the second cutting section 111, and the second cutting section 111 is adapted to cooperatively perform a diagonal-cutting function.

The first and second jaw portions 108, 118 may also respectively include first and second grooves 124, 130 that cooperatively define a gripping aperture 150 defining a gripping feature when the first and second jaw portions 108, 118 are brought into a substantially closed position. The first and second grooves 124, 130 may be respectively disposed on the third and fourth cutting edges 122, 128, or between the first and second cutting edges 120, 126 and the third and fourth cutting edges 122, 128. The gripping aperture 150 may receive a wire or other object which may be gripped by the first and second grooves 124, 130 of the first and second jaw portions 108, 118 in order to twist, bend, pull, or otherwise manipulate the wire or object. The gripping aperture 150 also provides a visual indication for a user to determine whether an object to be cut is positioned in the first or second cutting sections. The first and second grooves 124, 130 may be disposed on the jaw portions 108, 118 at positions that are equidistant from the pivot. The jaws may also be asymmetrical, where the groove is only present on one of the jaws.

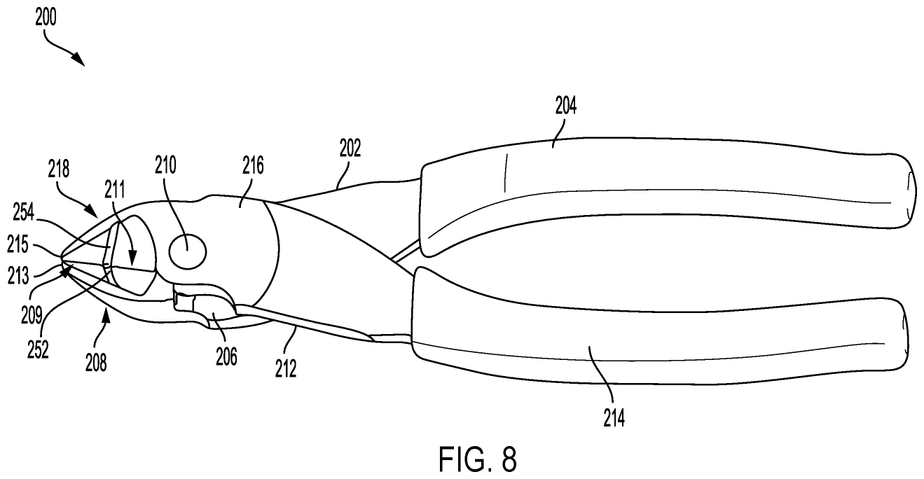

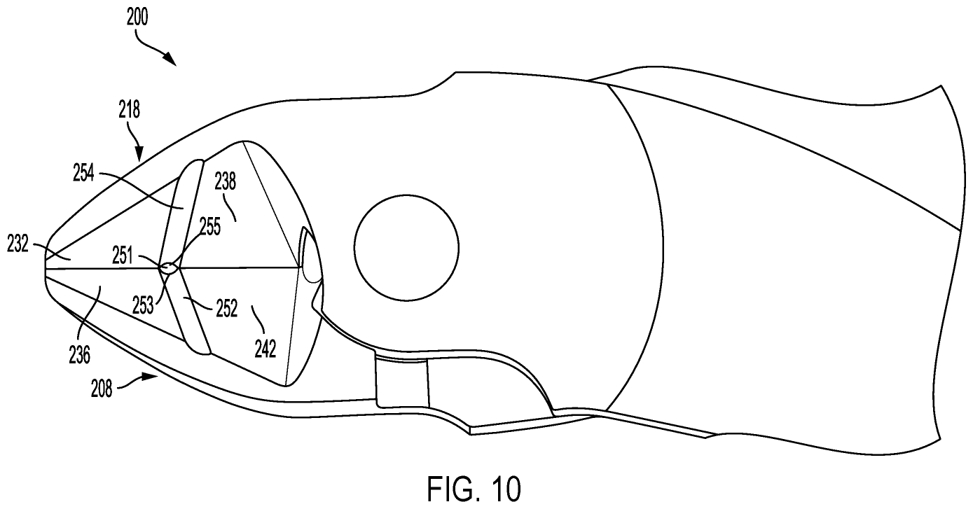

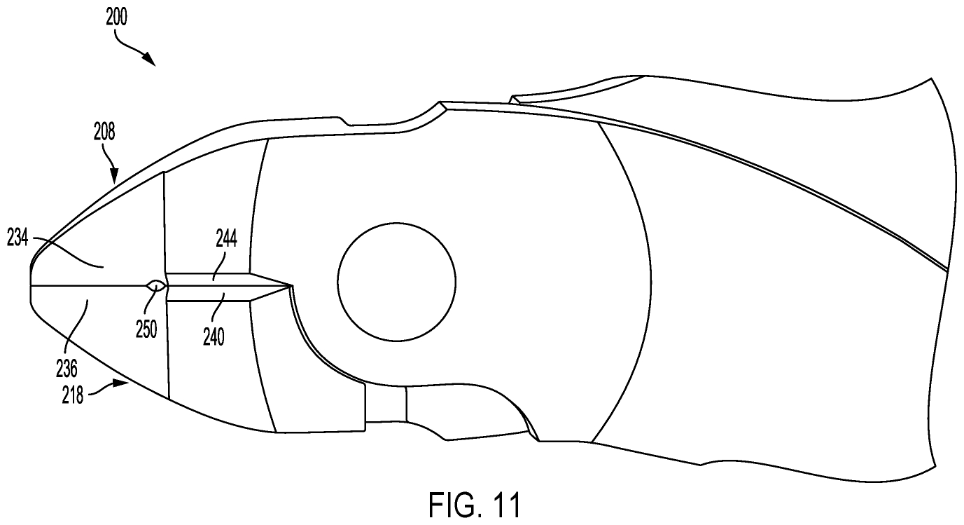

Referring to FIG. 8-11, another embodiment of tool 200 is shown. The tool 200 includes first and second halves 202, 212 that are pivotably coupled via a pivot 210. The first half 202 includes a first handle portion 204, a first joint portion 206, and a first jaw portion 208. The second half 212 includes a second handle portion 214, a second joint portion 216, and a second jaw portion 218.

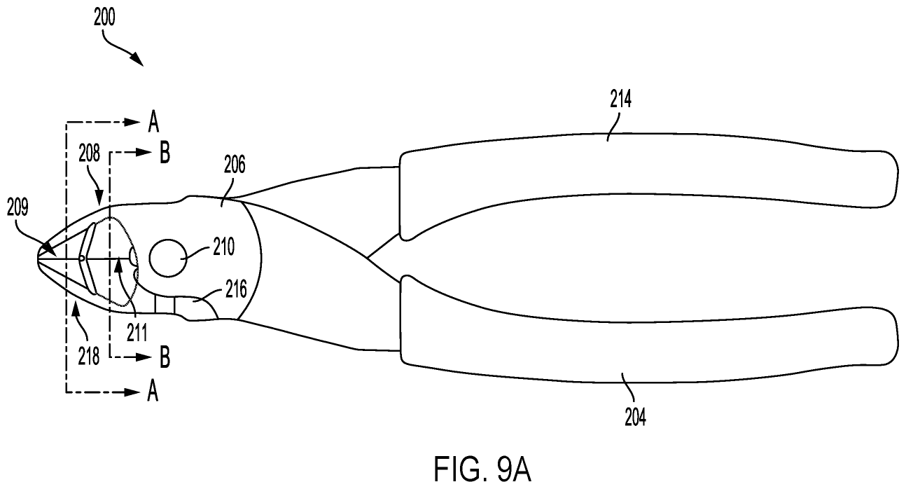

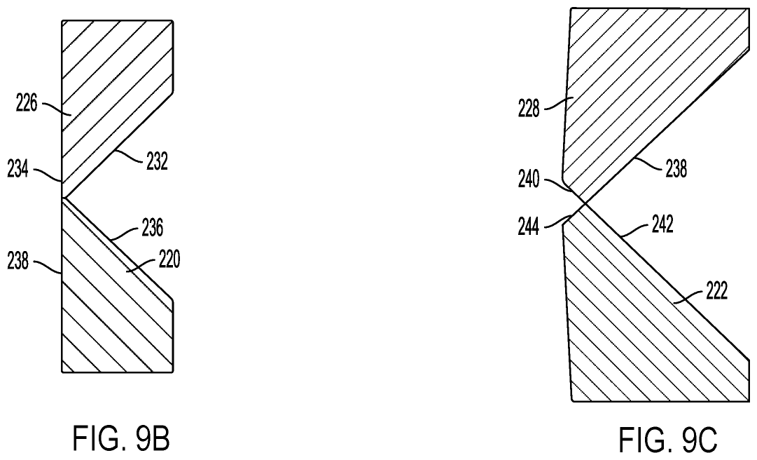

In an embodiment, the first and second jaw portions 208, 218 may respectively include first and second tips 213, 215. The first and second jaw portions 208, 218 also have first and second cutting edges 220, 226 cooperatively having a first cutting characteristic, and third and fourth cutting edges 222, 228 cooperatively having a second cutting characteristic different than the cutting characteristic of the first and second cutting edges 220, 226. The first cutting edge 220 and the second cutting edge 226 may define a first cutting section 209, and the third cutting edge 222 and the fourth cutting edge 228 may define a second cutting section 211. As shown in FIG. 9A, 9B, and 9C, the first and second cutting sections 209, 211 may respectively have different cross-sections that respectively provide different cutting properties. The first cutting edge 220 of the first jaw portion 208 may be respectively formed by exterior walls 232, 234 of the first jaw portion 208, and the second cutting edge 226 of the second jaw portion 218 may be formed by walls 236, 238 of the second jaw portion 218. As shown in FIG. 9B, the first cutting edge 220 of the first jaw portion 208 is defined by the angled wall 232 and a flat wall 234, and the second cutting edge 226 of the second jaw portion 218 is defined by the angled wall 236 and flat wall 238. The first and second cutting edges 220, 226 cooperatively define the first cutting section 209, which may be adapted to provide a flush-cutting function. The flat walls 234, 238 are substantially parallel to a cutting plane, where the cutting plane extends in the direction of the longitudinal axis of the tool 200 and is perpendicular to a pivot axis of the tool 200. The flat walls 234, 238 are substantially co-planar with each other. The angled walls 232, 236 respectively form an acute angle with the flat walls 234, 238 to form the respective first and second cutting edges 120, 126.

As shown in FIG. 9C, the third cutting edge 222 of the first jaw portion 208 may be formed by walls 238, 240 of the first jaw portion 208, and the fourth cutting edge 228 (also referred to as the second half second cutting edge) of the second jaw portion 218 may be formed by walls 242, 244 of the second jaw portion 218. As shown, all of the walls 238, 240, 242, 244 are angled walls that cooperatively form the second cutting section 211, and the second cutting section 211 is adapted to perform a diagonal-cutting function.

The first and second jaw portions 208, 218 may also respectively include first and second indents 253, 255 that cooperatively define a wire stripping aperture 251 when the first and second jaw portions 208, 218 are disposed in a substantially closed position, and the wire stripping aperture 251 is adapted for stripping a coated wire. The first and second indents 253, 255 may be disposed on the respective first and second cutting edges 120, 126, or between the first and cutting edges 120, 126 and the third and fourth cutting edges 122, 128. The first and second indents 253, 255 may be disposed on the jaw portions 108, 118 at a positions that are equidistant from the pivot. The respective exterior surfaces of the first and second jaw portions 208, 218 may respectively include first and second channels 252, 254 that extend from the wire stripping aperture 251. The first and second channels 252, 254 may assist in guiding a wire into a desired position for the wire-stripping function, and the first and second channels 252, 254 may also provide a visual indication between the first and second cutting sections 209, 211.

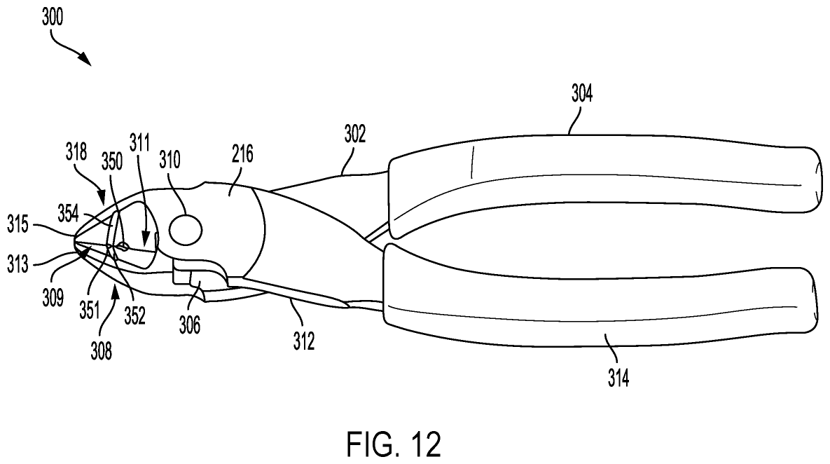

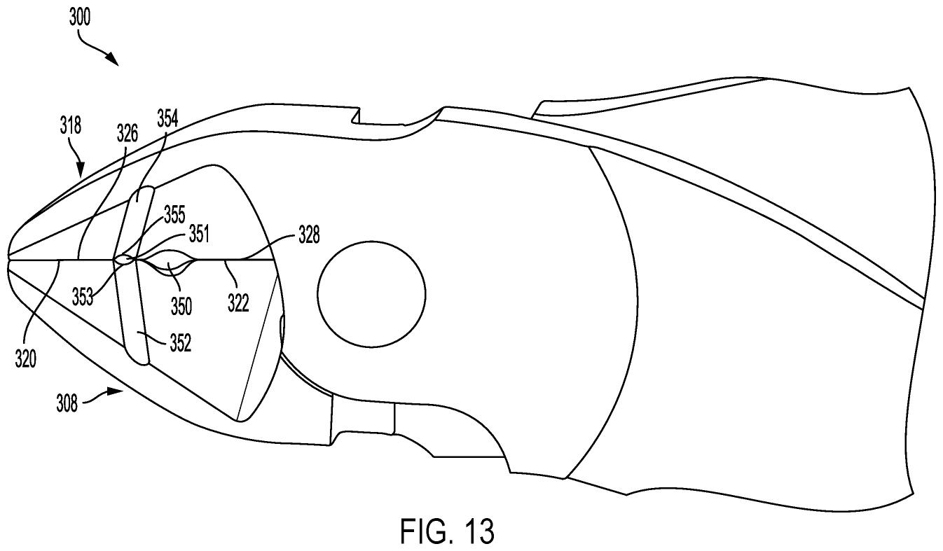

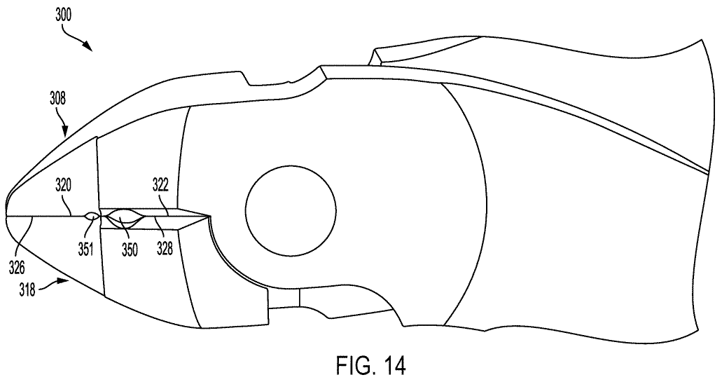

Referring to FIG. 12-14, another embodiment of a tool 300 is shown. The tool 300 includes first and second halves 302, 312 that are pivotably coupled via a pivot 310. The first half 302 includes a first handle portion 304, a first joint portion 306, and a first jaw portion 308. The second half 312 includes a second handle portion 314, a second joint portion 316, and a second jaw portion 318.

In an embodiment, the first and second jaw portions 308, 318 may respectively include first and second tips 313, 315. The first and second jaw portions 308, 318 also have respective first and second cutting edges 320, 326 cooperatively having a first cutting characteristic, and respective third and fourth cutting edges 322, 328 cooperatively having a second cutting characteristic different than the first and second cutting edges 320, 326. The first cutting edge 320 and the second cutting edge 326 may cooperatively define a first cutting section 309, and the third cutting edge 322 and the fourth cutting edge 328 may cooperatively define a second cutting section 311. The first and second cutting sections 309, 311 may have different respective cross-sections that provide different respective cutting properties, as similarly described in the embodiments of tool 100 and tool 200.

The first and second jaw portions 308, 318 may respectively include first and second grooves that cooperatively define a gripping aperture 350 when the first and second jaw portions 308, 318 are brought into a substantially closed position. The first and second grooves may be disposed on the respective second cutting edges 322, 328, or between the first cutting edges 320, 326 and the second cutting edges 322, 328. The gripping aperture 350 may receive a wire or other object which may be gripped by the first and second grooves of the first and second jaw portions 308, 318 in order to twist, bend, pull, or otherwise manipulate a wire or object.

The tool 300 also includes a wire stripping aperture 351, similar to the wire stripping aperture 251, described with respect to tool 200. The first and second jaw portions 308, 318 may respectively include first and second indents 353, 355 that cooperatively define a wire stripping aperture 351 when the first and second jaw portions 208, 218 are disposed in a substantially closed position, and the wire stripping aperture 351 is adapted, for example, stripping a coated wire. The first and second indents may be disposed on the respective first and second cutting edges 320, 326, or between the first and second cutting edges 320, 326 and the third and fourth cutting edges 322, 328. The wire stripping aperture 351 is disposed proximal to the first and second tips 313, 315 compared to the gripping aperture 350. The exterior surfaces of the respective first and second jaw portions 308, 318 may also include respective first and second channels 352, 354 that extend from the wire stripping aperture 351. The first and second channels 352, 354 may assist in guiding a wire into a desired position for the wire-stripping function, and the first and second channels 352, 354 may also provide a visual indication between the first and second cutting sections 309, 311.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool having first and second halves pivotally coupled together at a pivot and respectively having first and second jaw portions, the tool comprising:
a first cutting section cooperatively formed by first and second cutting edges respectively disposed on the first and second jaw portions;
a second cutting section cooperatively formed third and fourth cutting edges respectively disposed on the first and second jaw portions, wherein the second cutting section is disposed proximal to the pivot in relation to the first cutting section; and
a grip feature formed by a first groove disposed on the first jaw portion and disposed between the first and second cutting sections.

2. The tool of claim 1, wherein the grip feature includes a second groove disposed on the second jaw portion opposite the first groove, and the second groove is disposed between the first and second cutting sections.

3. The tool of claim 2, wherein the first and second grooves are substantially equidistant from the pivot.

4. The tool of claim 1, wherein the first and second cutting edges are each cooperatively formed by a first angled wall and a flat wall, wherein the flat wall is substantially perpendicular to a pivot axis extending through the pivot.

5. The tool of claim 4, wherein third and fourth cutting edges are each cooperatively formed by second and third angled walls.

6. The tool of claim 4, wherein the flat walls are substantially co-planar.

7. The tool of claim 1, further comprising an indent disposed on each of the first and second jaw portions, wherein the indents define a wire-stripping aperture between the first and second sets of cutting edges that is adapted to strip wire, and the indents are substantially equidistant from the pivot.

8. A tool comprising:
first and second halves pivotally coupled together at a pivot and respectively having first and second jaw portions;
a first cutting section cooperatively formed by first and second cutting edges respectively disposed on the first and second jaw portions;
a second cutting section cooperatively formed by third and fourth cutting edges respectively disposed on the first and second jaw portions, wherein the second cutting section is disposed proximal to the pivot in relation to the first cutting section; and
a wire-stripping feature cooperatively formed by first and second indents respectively disposed on the respective first and second jaw portions and between the first and second cutting sections.

9. The tool of claim 8, wherein the first and second cutting edges are each cooperatively formed by a first angled wall and a flat wall, wherein the flat wall is substantially perpendicular to a pivot axis extending through the pivot.

10. The tool of claim 9, wherein third and fourth cutting edges are each cooperatively formed by second and third angled walls.

11. The tool of claim 10, wherein the flat walls are substantially co-planar.

12. The tool of claim 8, further comprising first and second channels respectively disposed on of the first and second jaw portions and extending from the wire-stripping feature in a direction away from the wire-stripping feature.

13. The tool of claim 8, wherein the first and second indents are substantially equidistant from the pivot.

14. The tool of claim 8, wherein the second cutting portion extends substantially to the pivot.

15. A tool comprising:
first and second halves pivotally coupled together at a pivot and respectively having first and second jaw portions;
a first cutting section cooperatively formed by a first and second cutting edges respectively disposed on the first and second jaw portions;
a second cutting section cooperatively formed by third and fourth cutting edges respectively disposed on the first and second jaw portions, wherein the second cutting section is disposed proximal to the pivot in relation to the first cutting section;
a grip feature formed by a first groove disposed on the first jaw portion between the first and second cutting sections; and
a wire-stripping feature cooperatively formed by first and second indents disposed on the respective first and second jaw portions between the first and second cutting sections.

16. The tool of claim 15, wherein the grip feature includes a second groove on the second jaw portion opposite the first groove, and the second groove is disposed between the first and second cutting sections.

17. The tool of claim 16, wherein the first and second grooves are substantially equidistant from the pivot.

18. The tool of claim 15, wherein the first and second cutting edges are each cooperatively formed by a first angled wall and a flat wall, wherein the flat wall is substantially perpendicular to a pivot axis extending through the pivot.

19. The tool of claim 18, wherein third and fourth cutting edges are each cooperatively formed by second and third angled walls.

20. The tool of claim 19, wherein the flat walls of each of the first and second jaw portions are substantially co-planar.
